(19) United States
(12) Patent Application Publication
(10) Pub. No.: US 2005/0220392 A1
(43) Pub. Date: Oct. 6, 2005

(54) Optical integrated device

(76) Inventors: Jun-ichi Hashimoto, Yokohama-shi (JP); Tsukuru Katsuyama, Yokohama-shi (JP); Kenji Koyama, Yokohama-shi (JP)

Correspondence Address: Smith, Gambrell & Russell, Suite 800, 1850 M Street, N.W., Washington, DC, 20036, US

(21) Appl. No.: 11/091,719

(22) Filed: Mar. 29, 2005

(30) Foreign Application Priority Data
Mar. 30, 2004 (JP) 2004-099893

(51) Int. Cl. G02B 6/12

(52) U.S. Cl. 385/14

(57) ABSTRACT

The present invention provides an optical device integrating an active device with a passive device without any butt joint structure between two devices. The optical integrated device of the invention includes a GaAs substrate, first and second cladding layers, and an active layer sandwiched by the first and second cladding layers, these layers are disposed on the GaAs substrate. The GaAs substrate provides first to third regions. The active layer includes first to third active layers disposed on respective regions of the substrate. The first active layer has a quantum well structure whose band-gap energy smaller than 1.3 eV, while the third active layer has a quantum well structure whose band-gap energy is greater than that of the first active layer.

### BACKGROUND OF THE INVENTION

1. Field of the Invention

The present invention relates to an optical device that monolithically integrates an optically active device and an optically passive device.

2. Related Prior Art

Japanese patent published as S63-196088 has disclosed a semiconductor laser diode, an edge portion of which is widened in the band-gap energy by the diffusion of zinc (Zn) atoms. This edge portion functions as a window region for the coherent light. This window region with widened band-gap energy may prevent the laser from the COD (Catastrophic Optical Damage) and the degradation thereby.

Japanese patent published as 2001-148531 has disclosed an optically integrated device that includes an optical waveguide and an optical amplifier both provided on single GaAs substrate. The optical amplifier, optical coupled with the optical waveguide, comprises of an active layer made of GaₓIn₁₋ₓN_{y}As_{1-y}, first and second cladding layers sandwiching the active layer therebetween. The waveguide comprises a core made of GaInNAs or GaAs, and first and second cladding layers sandwiching the core.

Optical integrated devices applicable in a wavelength range longer than 1 μm may be processed on currently available InP substrate with 3 inch diameter. A semiconductor materials with greater band-gap energy than that of InP does not lattice-match to InP. Accordingly, in the InP system, which means that semiconductor materials considered have a lattice constant matching to that of InP, materials having comparably greater band-gap energy may not apply to the optical confinement layer and the cladding layer. This means that the band-gap difference between the active layer and layers surrounding the active layer, such as cladding layer and optical confinement layer, is not ensured, thereby reducing the carrier confinement into the active region and degrading the performance of the device against the temperature.

The former Japanese patent, S63-196088, has related to the improvement of the edge surface of the optical cavity, not relates to the optical integrated device. While, the latter Japanese patent, 2001-148531, has related to the optical integrated device applicable in the longer wavelength band. This integrated device includes an active layer made of GaInNAs related material. Since the lattice constant of GaInNAs matches to that of the GaAs, the GaAs wafer with relatively large size, 6 inches, may be used Moreover, since the GaAs related material, such as AlGaAs and AlGaInP and having comparably greater band-gap energy than InP, may be applicable to the cladding layer and the confinement layer, the band-gap difference between the active layer and the cladding layer becomes large, accordingly, the carrier confinement within the active layer becomes effective. Therefore, in the optical integrated device using GaInNAs, the performance against the temperature may be drastically improved as compared with the InGaAs(P)/InP system.

In such optical device integrating the active device with the passive device, the light processed in the active device is necessary to be not absorbed in the passive device. Accordingly, the band-gap energy of the passive device must be greater than that of the active device. On the other hand, both devices must be smoothly coupled to each other to eliminate the reflection of light at the interface therebetween. Therefore, the latter Japanese patent has disclosed a butt joint structure, in which the optically active regions of both devices are physically come into contact after independently processed or one of active regions is processed to come into contact to the other active region that is processed in advance.

However, in this butt joint structure, the layer structure in the active device and that in the passive device are occasionally different to each other, at least two structures may not be completely identical in the physical dimensions to each other, so the mode field diameter of the light in the active device and that in the passive device becomes different, accordingly, the reflection of light is inevitably induced at the interface.

Moreover, in the butt joint structure, the passive device is independently armed after the formation of the active device, i.e. the epitaxial layers for the passive device is, after the etching of layers for the active device, grown on thus etched portion. However, an extraordinary layer may be formed at the second growth, and this extraordinary layer degrades the interface and the optical coupling thereof which increase the reflection at the interface. Thus, the butt joint structure lacks the reliability and degrades the performance of the optical integrated device.

### SUMMARY OF THE INVENTION

According to the present invention, an optical integrated device is provided. The device comprises of a GaAs substrate, a first cladding layer, an active layer, and a second cladding layer. The substrate includes first to third regions arranged along a prescribed axis in this order. Two cladding layers and the active layer are grown on the GaAs substrate. One feature of the invention is that the active layer includes first to third active layers corresponding to respective regions in the substrate, and a thickness of the first active layer is greater than a thickness of the third active layer, accordingly, band-gap energy of the third active layer is greater than band-gap energy of the first active layer. The band-gap energy of the first active layer may be smaller than 1.3 eV.

In the present invention, the first to third active layers have substantially same layer configuration without any butt joint structure therebetween except that the respective thickness thereof are different to each other. Band-gap energy of the first active layer is smaller than 1.3 eV, and smaller than that of the third active layer. Therefore, light processed in the first active layer may propagate in the third active layer without substantial reflection at the interface between the first and third active layers, and may propagate in the third active layer without substantial absorption.

That is, the first to third active layers may have respective quantum well structures, thickness of which is greatest in the first active layer, is smallest in the third active layer and is intermediate in the second active layer, i.e. gradually decreases form the first active layer to the third active layer. Therefore, the bandgap energy of the third active layer is greatest in the third active layer.

The first and second active layers may be semiconductor layers composing at least nitrogen (N), or composing at least nitrogen (N), gallium (Ga), and arsenic (As). The first and second active layers may further contain at least antimony (Sb) or phosphorous (P). Since semiconductor material composing nitrogen, or at least nitrogen, gallium and arsenic may widen the band-gap energy as maintaining a lattice constant thereof matching to that of the GaAs substrate, not only a large sized wafer may be applicable but also the band-gap difference to the cladding layer makes large to confine carriers in effective in the active layer, thereby enhancing the performance of the optical integrated device.

Typical semiconductor materials for the active layer are preferably GaNAs, GaInNAs, GaNAsSb, GaNAsP, GaNAsSbP, GaInNAsSb, GaInNAsP, and GaInNAsSbP. While, typical materials for the first and second cladding layers are preferably AlGaInP, GaInP, and AlGaAs.

One preferable structure of the present device includes a ridge in the second cladding layer, and the integrated device may further include a current blocking layer to bury the ridge of the second cladding layer. Even in this structure of the second cladding layer, the first and second active layers may smoothly couple with each other.

Another preferable structure of the present integrated device provides a mesa including the second cladding layer and the active layer, or additionally including a portion of the first cladding layer. The device may further provide a current blowing layer to bury the mesa Even in this structure of the second cladding layer, the first and second active layers may smoothly couple with each other. Moreover, since the first and second active layers are limited in a width thereof the mode field diameter of the light in respective active layers becomes substantially identical to each other. Accordingly, the reflection at the interface may be disregarded.

The optical integrated device of the present invention preferably includes first and second optical confinement layers to confine carriers in effective into the active region, and to confine light in effective into the active region and these optical confinement layers. The first optical confinement layer is sandwiched by the active region and the first cladding layer, while the second optical confinement layer is sandwiched by the active region and the second cladding layer.

### BRIEF DESCRIPTION OF DRAWINGS

FIG. 1A is a perspective view showing an optical integrated device according to the present invention, and FIG. 1B is a schematic diagram showing a structure of an active region of the optical integrated device;

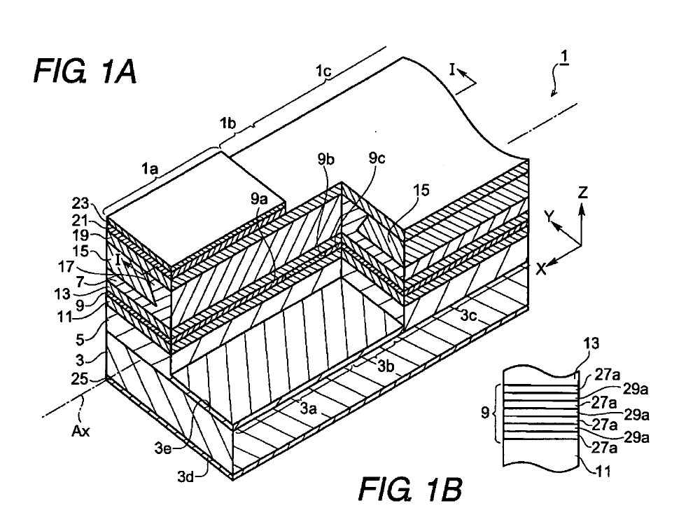

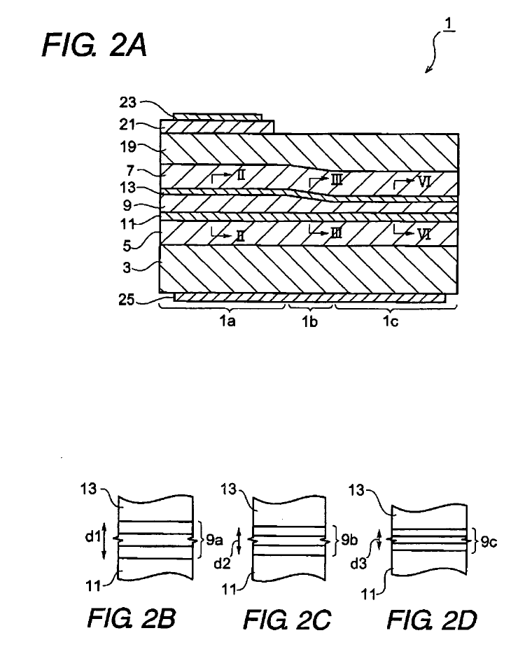

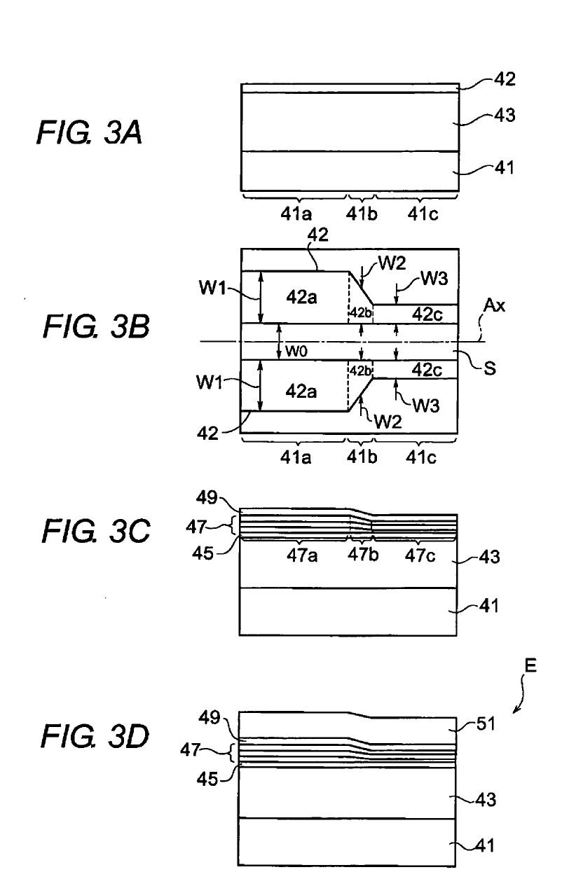

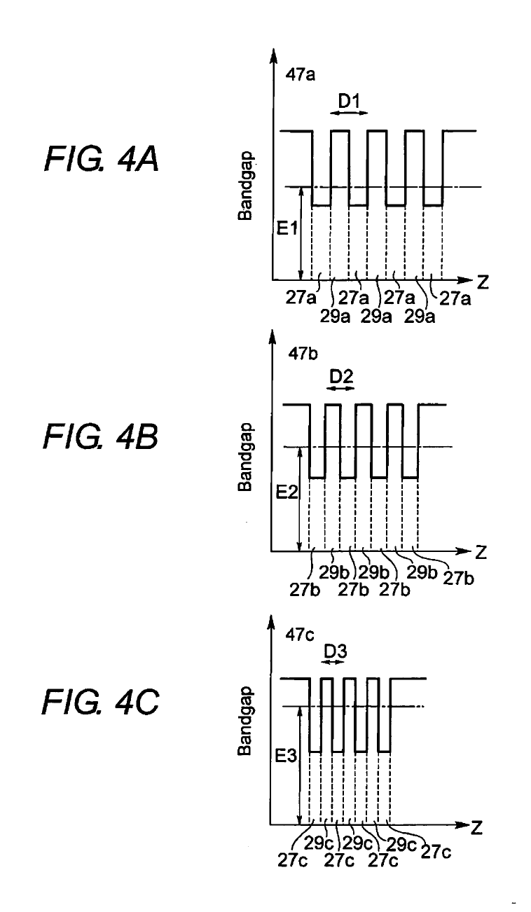

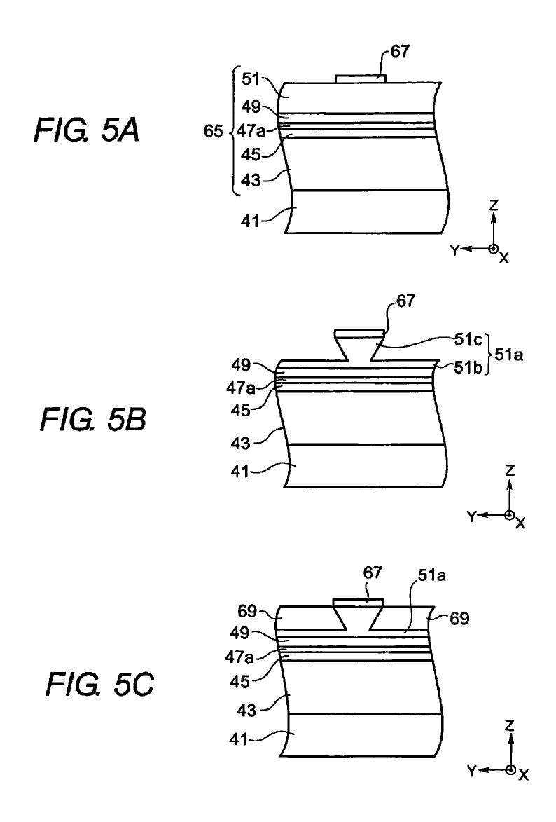

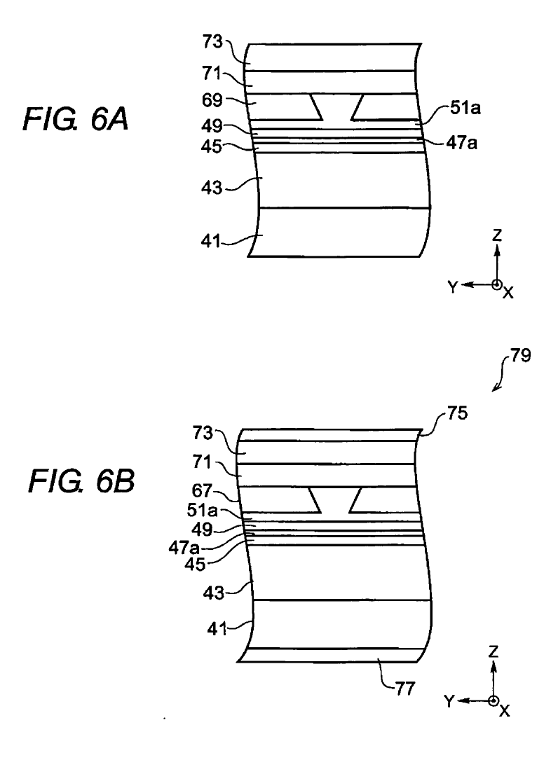

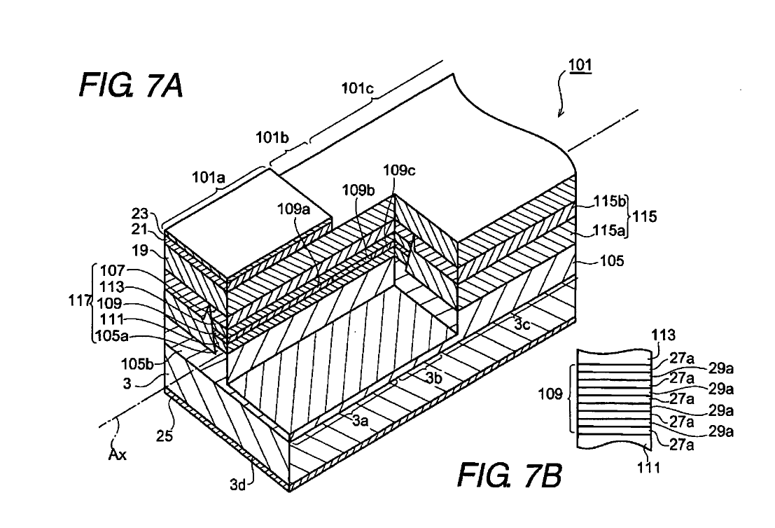

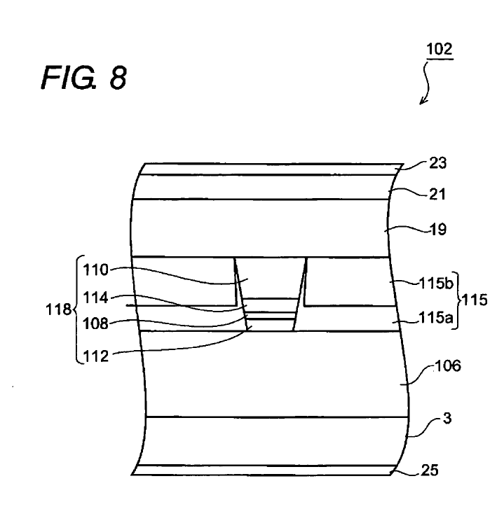

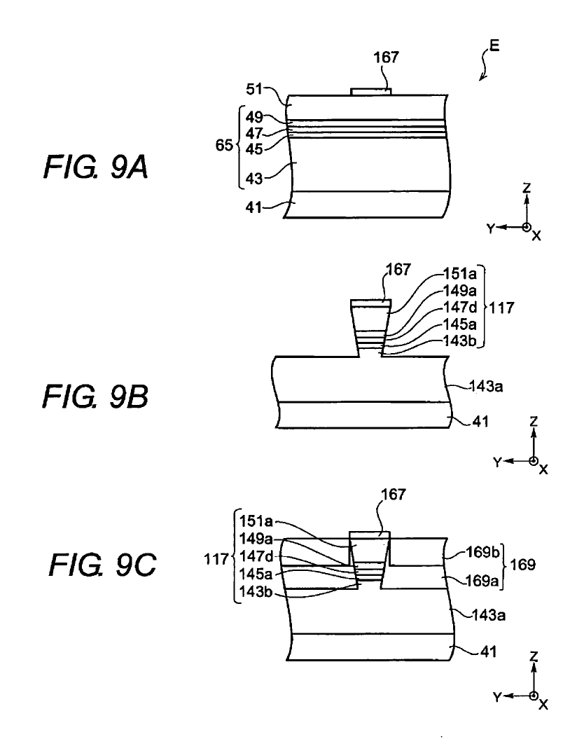

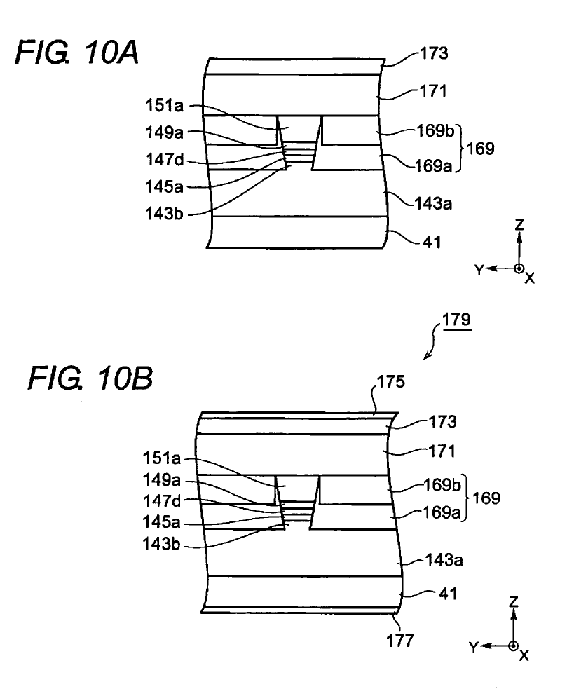

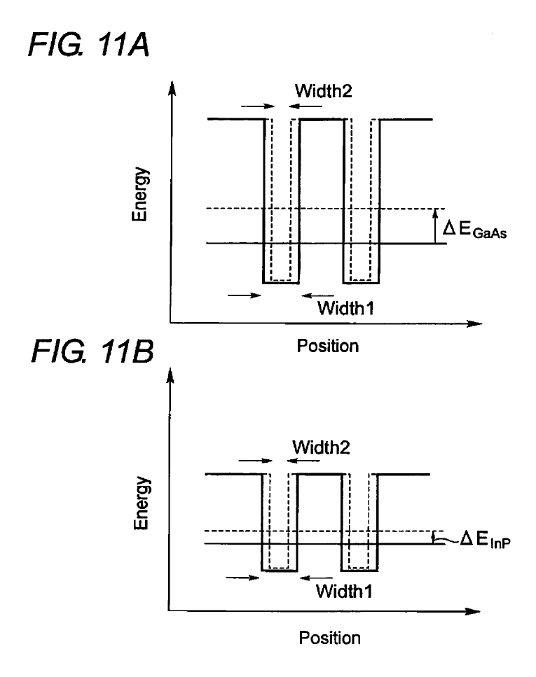

from FIG. 2A to FIG. 2D are cross sectional views of the optical integrated device each taken along the line I-I, the line II-II, the line III-III, and the line IV-IV shown in FIG. 1A, respectively;

from FIG. 3A to FIG. 3D show processes for manufacturing the optical integrated device according to the second embodiment of the invention, in particular, FIG. 3B shows a mask configuration used for the selective growth;

from FIG. 4A to FIG. 4C show schematic band diagrams of the quantum well structure in first to third active layers, respectively;

from FIG. 5A to FIG. 5C show a latter half process for manufacturing the optical integrated device;

FIG. 6A and FIG. 6B shows processes, subsequent to the process shown in FIG. 5C, for manufacturing the optical integrated device;

FIG. 7A is a perspective view showing an optical integrated device according to the third embodiment of the invention, and FIG. 7B shows an active region of the integrated device shown in FIG. 7A;

FIG. 8 is a cross section of a modified structure of the optical integrated device shown in FIG. 7A,

from FIG. 9A to FIG. 9C show processes for manufacturing the optical integrated device with the buried hetero-structure shown in FIG. 7A;

FIG. 10A and FIG. 10B show processes, subsequent to the process shown in FIG. 10C, for manufacturing the optical integrated device shown in FIG. 7A; and

FIG. 11A is a schematic band diagram of the quantum well structure for the GaAs based system, and FIG. 11B is a schematic band diagram of the quantum well structure for the InP based system.

### DESCRIPTION OF PREFERRED EMBODIMENTS

Spirits of the present invention will be easily understood by the following description as referring to accompanying drawings. Next, an optical integrated device of the invention will be described as referring to accompanying drawings. In the explanations and the drawings, if possible, same elements will be referred by same symbols or numerals without overlapping explanation.

### First Embodiment

FIG. 1A is a perspective view showing an optical integrated device 1 according to the present invention, and FIG. 1B is a schematic diagram showing a structure of an active region of the optical integrated device 1. From FIG. 2A is a cross section taken along the line I-I in FIG. 1A, while FIGS. 2B to 2D are cross sections taken along the line II-II, the line III-III, and the line IV-IV in FIG. 2A, respectively.

The optical integrated device 1 comprises a GaAs substrate 3, a first cladding layer 5, a second cladding layer 7, and an active layer 9. The GaAs substrate whose primary surface 3e is (100) crystallographic surface, with a first conduction type, for instance n-type, and provides first to third regions, 3a to 3c, These first to third regions are arranged along an axis Ax. The first cladding layer 5, showing the first conduction type, is formed in whole regions, 3a to 3c. The second cladding layer 7, showing a second conduction type, for instant p-type, is also formed in whole regions, 3a to 3c. The first and second cladding layers sandwich the active layer 9 therebetween The active layer 9 includes first to third active layers, 9a to 9c, corresponding to the regions, 3a to 3c, of the substrate 3. The first active layer 9a, as shown in FIG. 1B, has band-gap energy smaller than 1.3 eV, which is equivalent to a wavelength of 0.95 μm and different to that of the third active layer 9c.

As shown in from FIG. 2B to FIG. 2C, the first to third active layers, 9a to 9c, provide respective quantum well structures, namely, a thickness d1 of the first active layer 9a is greater than the thickness d3 of the third active layer. In the second active layer 9b, thickness gradually thins down from the first active layer 9a to the third active layer 9c. The band-gap energy of second and third active layers, 9b and 9c, is greater than that of the first active layer 9a.

In the conventional integrated device with the butt joint structure, the growth of the semiconductor layers for the passive device is carried out independent of the growth for the active device, namely, growth conditions for the active device and the passive device must be independently adjusted. Such independent process is quite hard to obtain desired quantum well structures for respective layers.

On the other hand, the present integrated device 1 has three active layers, 9a to 9c, but the growth thereof, as explained later, may be carried out in simultaneous by the selective growth technique using the particular mask member. Therefore, the quantum well structures ar respective active layers may be well and precisely controlled.

The active layers, 9a to 9c, may include a group III-V compound semiconductor layer composing nitrogen (N), or may include a semiconductor layer composing nitrogen (N, gallium (Ga) and arsenic (A). Since the semiconductor material grouped in the III-V compound semiconductor and composing nitrogen (N) may have a lattice constant substantially matching to that of GaAs, accordingly, such semiconductor materials may be easily grown on the GaAs substrate 3. Moreover, such materials may have a wide range of the band-gap energy by adjusting the composition thereof with maintaining the lattice constant substantially matching to that of GaAs.

In the present device, such semiconductor material may contain at least antimony (Sb) and phosphorous (P). Even when these elements are involved in, the lattice constant thereof may be left as substantially matching to that of GaAs. The antimony (Sb) operates as a surfactant, which suppresses the three dimensional growth of the semiconductor layer containing nitrogen (N), thereby improving the crystal quality. On the other hand, the phosphorous (P) may reduce the localized crystal deformation and may enhance the capture of the nitrogen atoms into the crystal.

The active layer 9 may be GaNAs, GaInNAs, GaNAsSb, GaNAsP, GaNAsSbP, GaInNAsSb, GaInNAsP, and GaInNAsSbP. These semiconductor materials have the lattice constant substantially equal to or similar to that of GaAs, and may be widely changed in their band-gap energy by adjusting the composition of respective elements.

The first and second cladding layers, 5 and 7, have band-gap energy greater than that of the active layer 9, which enables carriers to be confined in the active layer 9. Moreover, refractive indices of the first and second cladding layers, 5 and 7, are smaller than that of the active layer 9, which confines light within the active layer 9. These cladding layers, 5 and 7, may be one of or a combination of AlGaInP, GaInP, and AlGaAs.

The optical integrated device 1 may further provide a first and a second optical confinement layers, 11 and 13, respectively, to sandwich the active layer 9. The band-gap energy of these optical confinement layers, 11 and 13, is smaller than those of the first and second cladding layers, 5 and 7, and is greater than that of the active layer 9. Therefore, the carriers are effectively confined in the active layer 9 by the cladding layers, 5 and 7, and the optical confinement layers, 11 and 13. On the other hand, refractive indices of the optical confinement layers, 11 and 13, are smaller than that of the active layer 9, and are greater than those of the cladding layers, 5 and 7. Therefore, the cladding layers, 5 and 7, may confine light within the optical confinement layers, 11 and 13, and within the active layer 9. The opal confinement layers, 11 and 13, may be one of or a combination of GaAs, GaInAsP, AlGaAs, AlGaInP, and GaInP.

The optical integrated device 1 further comprises a current blocking layer 15 disposed on the second cladding layer 7 to bury a ridge 17 therein formed by the second cladding layer 7. The current blocking layer 15 may be a semiconductor material with high resistivity to concentrate carriers into the ridge 17. On the current blocking layer 15 and the ridge 17 is provided with a third cladding layer 19 with the second conduction type and a refractive index smaller than that of the active layer 9. The current blocking layer 15 may be one of, or a combination of, AlGaInP, GaInP, and AlGaAs. These materials may provide the current blocking layer with greater band-gap energy.

On the third cladding layer, 19 may be provided with a contact layer 21 having the second conduction type and low resistivity. The first device 1a provides first and second electrodes, 23 and 25, respectively. The first electrode 23 is formed on the contact layer 21, while the second electrode 25 is on the back surface 3d of the GaAs substrate 3. When the first conduction type is n-type, the first and second electrodes, 23 and 25, function as an anode and a cathode, respectively. Moreover, the optical integrated device 1 may provide, in the second device 1b, at least one of another contact layer and a third electrode both isolated from the contact layer 21 and the first electrode 23. The contact layer may be GaAs.

### Second Embodiment

Next, a process, in the first hall, or manufacturing the optical integrated device shown in FIG. 1A will be described as referring to drawings from FIG. 3A to FIG. 3D.

As shown in FIG. 3A, a plurality of semiconductor layers is grown on the GaAs substrate 41 by using the Organo-Metallic Vapor Phase Epitaxy technique (OMVPE). First, the first cladding layer 43 is grown on the GaAs substrate 41. In FIG. 3A, regions from 41a to 41c, which are arranged along a prescribed line, correspond to regions from 3a to 3c of the GaAs substrate 3 shown in FIG. 1A

Next, the active layer 47 and two opal confinement layers, 45 and 49, are grown on the first cladding layer 43. Prior to the growth of these layers, a mask 42 is formed on the first cladding layer 43. FIG. 5B is a plan view showing the plane shape of the mask 42. That is, the mask comprises first to third portions, 42a to 42c corresponding to regions from 41a to 41c of the GaAs substrate 41. The widths of respective portions are w1, w2, and w3, respectively. The width w1 is greater than the width w3, and the width w2 gradually narrows along the aria Ax from the first portion 42a to the third portion 42c.

The first optical confinement layer 45, the active layer 47 and the second optical confinement layer 49 are grown successively in this order on the first cladding layer 43 (FIG. 3C). The active layer 47, in this embodiment, includes first to third active layers, 47a to 47c corresponding to and reflecting characteristics of portions 42a to 42c of the mask 42.

In the crystal growth, in particular, the growth of the semiconductor film, source materials pouring on the mask diffuse and accumulates on a region where the surface of the semiconductor material exposes. That is, source materials supplied in the stripe S become a maximum in the first region 42a, and a minimum in the third region 42c, because the width of the mask 42 is widest in the first region 42a and narrowest in the third region 42c.

Therefore, the growth rate of the semiconductor layer is fastest in the first region 42a, when the multi-quantum well strut is armed by the mask 42, the thickness of the active layer becomes the maximum and the shift of the energy level due to the quantum effect becomes the minimum in the first region 42a. Accordingly, the band-gap energy becomes the minimum in the first active layer 47a, while becomes the maximum in the third active layer 47c. Thus, the optical device can be obtained in which the active device is monolithically integrated with the passive device with relatively greater band-gap energy to that of the active device. Moreover, by varying the plane shape of the mask 42, especially in the region 42b thereof, the band gap profile of the active layer 47 along the axis Ax may be adjusted to connect the first active layer 47a in smooth to the third active layer 47c with substantially no optical loss even if two layers, 47a and 47c have discrepancy in the mode field diameter.

In the present embodiment, the thickness of respective layers are, 1500 nm for the first cladding layer 43, 100 nm for the first confinement layer 45, 100 nm for the second confinement layer 49, 8 nm for the first active layer 47a, and 6 nm for the third active layer, respectively.

After the growth of the active layer 47, the mask 42 is removed and the second cladding layer 51 with the second conduction type is grown on the second confinement layer 49, as shown in FIG. 3D. The first active layer 47a is thus formed on the first region 41a or the first device 1, while the third active layer 47c is formed on the third region 41c or the second device 2

The band gap diagram of respective active layers will be described below. FIG. 4A shows a band gap diagram of the first active layer 47a, which includes a quantum well structure comprising well layers 27a and barrier layers 29a. FIG. 4B shows a band gap diagram of the second active layer 47b, which also includes a quantum well structure comprising well layers 27b and barrier layers 29b. FIG. 4C is a band gap diagram of the third active layer 47c, which includes a quantum well structure comprising well layers 27c and barrier layers 29c.

The first active layer 47a has the well layer 27a thicker than the well layer 27c of the third active layer 47c, and has the barrier layer 29a thicker than the barrier layer 29c of the third active layer. The well layer 27b has intermediate thickness between two well layers, 27a and 27c, and the barer layer 29b also has intermediate thickness between two barrier layers, 29a and 29c.

The mode field diameter of the light propagating in the first active layer 47a is different to that of the light propagating in the third active layer. However, because the second active layer has thickness of the well and the barrier gradually varying from the first active layer 47a to the third active layer 47c, the reflection of the light may be decreased at the interface between the first device with the first active layer 47a and the second device with the third active layer 47c.

Moreover, the period D3 of the quantum well structure in the third active layer 47c is smaller than the period D1 in the first active layer 47a. The second active layer 47b has the quantum well structure, the period D2 of which is intermediate between that of the first active layer 47a and the third active layer 47c. Therefore, The quantum energy level E3 of the third layer 47c is higher than the quantum energy level E1 of the first active layer 47a, and the quantum energy level E2 of the second active layer 47b is intermediate between first and third active layers, 47a and 47c. Therefore, light processed in the first active layer 47a can propagate in the third active layer 47c without substantially any absorption

Next, the latter half of the process will be described as referring to drawings from FIG. 5A to FIG. 6B. As shown in FIG. 5A, an insulating film 67 such as SiO₂ or SiN is formed on the semiconductor layers 65. As shown in FIG. 5B, a portion of the second cladding layer 51 is etched by using this insulating film 67. Thus etched second cladding layer 51a comprises a flat portion 51b covering the whole surface of the second optical confinement layer 49, and the ridge 51c arranged on the flat portion 51b. The ridge 51c has a stripe extending along the axis Ax in FIG. 1A The cross section of the ridge 51c depends on the crystallographic orientation and the etchant. In the present embodiment, the ridge 51c shows a reverse mesa.

Next, the current blocking layer 69 is selectively grown, by the OMVPE technique, in both sides of the ridge 51c on the flat portion Sib to bury the ridge 51c (FIG. 5C). The blocking layer 69 concentrates carriers supplied from electrodes into the ridge 51c, such that the blocking layer 69 may be made of a material with high resistivity or a semiconductor material with a conduction type opposite to that of the second cladding layer 51.

Subsequent to the growth of the current blocking layer 69, the third cladding layer 71 and the contact layer 73 are grown on the ridge 51c and the current blocking layer 69 (FIG. 6A). The conduction type of the third cladding layer 71 and that of the contact layer 73 are same with the second cladding layer 51. Finally, as shown in FIG. 6B, the first electrode 75 is formed on the contact layer 73, while the second electrode 77 is on the back side of the GaAs substrate 41, thus completes the optical integrated device 79.

In the optical integrated device 79, respective active layers, 47a and 474, are formed by the angle growth, and the band-gap difference therebetween may be realized by the selective growth of the active layers, 47a and 47c. The layer structures of the first device 1a and the second device 1b are substantially same to each other except that the structure of respective quantum well structure. However, these quantum well structures may be simultaneously formed by using the particular mask for the selective growth.

Due to the discrepancy in the quantum well structure in respective active layers, 47a and 47c, the mode field diameter propagating in the first device 1a is slightly different to the mode field diameter of the light in the second device 1b. However, because of the existence of the second active layer 47b between the first and third active layers, 47a and 47c, the mode field diameter of the light gradually changes in this layer 47b, thereby substantially preventing the light reflected at the interface between the first and third active layers, 47a and 47c. Moreover, the present optical device has the following advantages considering the structure and the process thereof into account:

(1) The optical power loss between the first device 1a and the second device 1b may be reduced compared with the conventional butt joint structure. In the butt joint structure, the layer configurations in the first device 1a and that in the second device 1b are considerably different, which results on the different mode field diameter in respective devices. Therefore, the scant reflection may occur at the interface between two devices. Moreover, the abnormal growth may occasionally occur at the edge of the first device when layers for the second device are epitaxially grown, which also increases the reflection at the interface.

(2) The present process may reduce the number of epitaxial growth and the etching. That is, in the conventional device, the etching for the first waveguide and the epitaxial growth for the second waveguide are necessary, which makes the process complex and costly. On the other hand, the present process requires single epitaxial growth, selective growth, for forming active layers, which enhances the reproducibility and the reliability of the process.

Moreover, the ridge waveguide applied in the present device is unnecessary to etch the active region in the first device and the waveguide in the second region, which escapes from the degradation of the device originated from this etching, thereby enhancing the reliability of the device.

### Third Embodiment

FIG. 7A is a perspective view showing another optical integrated device 101 according to the third embodiment of the invention, and FIG. 7B is a schematic diagram showing a layer of an active layer of the device shown in FIG. 7A.

The optical integrated device 101 provides a similar structure to those shown in the previously explained device 1 except that the active layer 109, the first cladding layer 105, and the upper and lower optical confinement layers, 111 and 113, form a mesa 117, while only the upper cladding layer makes the ridge in the first embodiment.

As explained in the former embodiment, the mesa 117 extends from the first region 3a to the third region 3c. The active layer 109a in the first device 101a also smoothly continues to the third active layer 109c via the second active layer 109b. The active layers, from 109a to 109c, are sandwiched by the first and second optical confinement layers, 111 and 113, in whole regions, 101a to 101c. Therefore, advantages appeared in the first embodiment are also maintained in this integrated device 101.

The current blocking layer 115 in this device 101, disposed on the flat portion 106b of the first cladding layer 105 to bury the mesa 117, which is called as the buried hetero-structure. The current blocking layer 115 may include a reverse-biased pn-junction, that is, the current blocking layer 115 includes a first blocking layer 115a with the second conduction type and a second blocking layer 115b with the first conduction type provided on the first blocking layer 115a. The pn-junction thus formed is biased in reverse when the active layer 109 with the first and second cladding layers, 105 and 107 are biased in forward, accordingly, substantially no leak current flow in the current blocking layer 115, which concentrates carries injected from the electrode into the mesa 117.

The current blocking layer 115 may be AlGaInP, GaInP, and AlGaAs, these semiconductor materials show the band-gap energy greater than that of the InP, thereby enhancing the current blocking function.

The optical integrated device 101 may include the same semiconductor materials as those of the first embodiment 1. For instance, semiconductor materials for the first to third cladding layers, 105, 107 and 19, for the first and second optical confinement layers, 111 and 113, and for the quantum well layers and the barer layers, 27 and 29, for the contact layer 21, all of which may be same as those used in the first optical device 1. Moreover, the first active layer 109a has the multi-quantum well structure as shown in FIG. 7b, the band diagram of which is the same with that shown in FIG. 4A, while the third active layer 109c has the same band diagram with that shown in FIG. 4C. That is, as compared to the first active layer 109a, the third active layer 109c has a small thickness than that of the first active layer 109a, accordingly, the band-gap energy thereof becomes greater than that of the first active layer 109a. The light generated in the first device 101a may propagate in the second device 101b without being absorbed therein.

FIG. 8 is a cross con showing a modified structure of the optical integrated device 102 compared to that shown in FIG. 7A. The optical integrated device 102 has a mesa 118 including the first and second optical confinement layers, 112 and 114, the active layer 108, and the second cladding layer 110. The mesa 118 excludes the first cladding layer 106 in this optical device 102. By selecting the semiconductor material of the first cladding layer 106 and materials used in the mesa 118, the mesa 118 may be easily etched in selective to the first cladding layer 106.

For example, the second cladding layer 110 may be AlGaInP and GaInP, the optical confinement layers, 112 and 114, may be AlGaAs, GaAs, and GaInNAsP lattice matching to the GaAs, and the quantum well layers may be GaNAs, GaInNAs, GaNAsSb, GaNAsP, GaNAsSbP, GaInNAsSb, GaInNAsP or GaInNAsSbP. When the cladding layer, the active layer and the optical confinement layers are made of materials mentioned above, by using a phosphoric acid solution, the active layer 108 and the confinement layers, 112 and 114 may be selectively etched to the first cladding layer 106. Thus, the structure shown in FIG. 8 can be easily obtained.

In this process of selectively etching the mesa 118, since the first cladding layer 106 operates as an etch-stopping layer, the mesa 118 may be formed with good reproducibility and homogeneity. The width of the mesa 118 depends on the thickness thereof. Accordingly, the selective etching process mentioned above improves the reproducibility and the homogeneity of the width of the mesa.

### Fourth Embodiment

Next, the process for manufacturing the optical integrated device having the buried hetero-structure shown in FIG. 7A will be described in detail as referring to drawings from FIG. 9A to FIG. 10B.

As described previously, semiconductor layers of the first cladding layer 43, the first optical confinement layer 45, the active layer 47 that includes a plurality of well layers and a plurality of barrier layers, the second confinement layer 49, and the second cladding layer 51 are successively grown on the GaAs substrate 41. On the GaAs substrate 41 is provided with a first region 41a for the first device and a second region 41c for the second device.

The band-gap energy of the third active layer 47c is widened, by aforementioned growth method as referring to drawings in FIG. 3, which forms an epitaxial layers E as shown in FIG. 9A. That is, an active device in the first region and a passive device with relatively wider band-gap energy in the second region are monolithically integrated to each other.

Next, the process for manufacturing the optical device using this epitaxial layers E will be explained. An insulating film 167 made of SiO₂ or SiN is formed on the top surface of the layers E.

By using this insulating film 167, the second cladding layer 51, the first and second confinement layers, 46 and 49, the active layer 47, and a portion of the first cladding layer 43c, are etched, thus forms a mesa 117 including the second cladding layer 151a, the active layer 147d, the first and second confinement layers, 145a and 149a, and a portion of the first cladding layer 143b. The cross section of the mesa 117 depends on the crystallographic orientation thereof and on the etchant for forming the mesa.

The current blocking layer 169 is grown selectively only on the flat portion 143a of the first cladding layer 143 without removing the insulating film 167, which buries the mesa 117. The blocking layer 169 comprises of the first blocking layer 169a showing the same conduction type with the second cladding layer 151a and the second blocking layer 169b, disposed on the first blocking layer 169a, showing the same conduction type with the first cladding layer 143a. When the active layer 147d is forwardly biased, these two blocking layers, 169a and 169b, are biased in backward, which induces a large built-in potential at the interlace between two layers, 169a and 169b, thus preventing carriers from flowing therethrough and, accordingly, concentrating carriers into the mesa 117. In a modification, the current blocking layer may be a material with high resistivity.

Subsequent to the process for burying the mesa by the current blocking layer 169, the second epitaxial growth of the third cladding layer 171 and the contact layer 173 is carried out The conduction type of the third cladding layer 171 and that of the contact layer 173 are the same with the second cladding layer 151a. Finally, the first and second electrodes, 175 and 177, are formed on the contact layer 173 and the back surface of the GaAs wafer 41, respectively, thus completing the optical integrated device 179.

The optical device 179 has similar advantages to those already explained accompanying with the first embodiment. Moreover, in particular for the optical integrated device with the buried hetero-structure, since the active region has a finite width, i.e. both sides of which are buried with the current blocking layer, the carriers are effectively concentrated in the narrow region of the mesa 117 and converted into photons. Further, the light thus generated in the active region 147d is effectively confined in the mesa 117, thereby reducing the optical loss therein.

FIG. 11 compares two quantum well structures, one of which shows the band diagram for semiconductor materials lattice constant thereof substantially matching to that of the GaAs (FIG. 11A), while the other, FIG. 11B, shows a band diagram for materials whose lattice constant being substantially matching to that of the InP. In respective drawings, solid line denotes the band diagram for the quantum well structure with relatively thick layers, while dotted lines correspond to the quantum well structure with relatively thin layers.

The combination of the GaAs substrate and the quantum well layer composing at least nitrogen (N), FIG. MIA, shows deeper well compared to the combination of the InP substrate with the quantum well layer lattice matching to the InP substrate, FIG. 12B. For example, for the InP based system, when the barrier layer is InP, the band-gap energy is 1.35 eV, and the quantum well layer is made of GaInNAsP whose band gap energy is 0.95 eV which corresponds to 1.3 μm, the well depth becomes 0.4 eV. On the other hand, when the same wavelength and the band-gap energy of the well layer made of GaInNAs are assumed, the well depth thereof becomes 0.95 eV, because the band-gap energy of the barrier layer made of GaInP lattice matching to the GaAs substrate is 1.9 eV.

When the quantum well structure are selectively grown, thickness of which are Width1 and Width2, respectively, the shift of the quantum level ΔE_{GaAs} for the GaAs based system is greater than the shift ΔE_{InP} for the InP based system, because the former system has the deeper well potential. This means that, a comparable energy shift of the quantum level can be obtained by a smaller change of the thickness in the GaAs based system. Therefore, in the GaAs based system, compared to the conventional InP based system, the flexibility of designing the mask for selective growth can be enhanced, accordingly, various types of integrated devices may be realized with a simple configuration of the mask. Moreover, the substantial difference in the quantum level can be obtained by a small difference in the thickness of layers. Accordingly, the optical loss due to the discrepancy of the mode field of the light may be prevented.

According to the present invention, the active device and the passive device may be monolithically integrated. The active device may be a semiconductor light emitting diode, a semiconductor laser diode, a semiconductor amplifier, a semiconductor optical modulator of an electro-absorption type, a semiconductor optical modulator of a Mach-Zehnder type, a semiconductor directional coupler and a semiconductor photodiode. The passive device may be an optical waveguide with a straight configuration or with a curved configuration, and an optical coupler such as an optical Y-branch device, an optical directional coupler, a multi-mode interference device, and an arrayed waveguide.

While the invention has been particularly shown and described with references to preferred embodiments thereof it will be understood by those skilled in the art that various changes in form and details may be made therein without departing from the spirit and scope of the invention as defined by the appended claims.

1. An optical integrated device, comprising:
a GaAs substrate having a first region, a second region and a third region arranged along a prescribed axis in this order;
a first cladding layer disposed on said GaAs substrate;
an active layer disposed on said first cladding layer; and
a second cladding layer disposed on said active layer,
wherein said active region provides a first active layer disposed on said first region, a second active layer disposed on said second region, and a third active layer disposed on said third region, said first active layer having a first thickness greater than a thickness of sad third active layer, said second active layer having a second thickness gradually thinning from said first active layer to said third active layer, said first active layer having band-gap energy smaller than 1.3 eV and said third active layer having band-gap energy greater than said band-gap energy of said first active layer.

2. The optical integrated device according to claim 1,
wherein said active layer includes a semiconductor layer made of group III-V compound semiconductor material composing at least nitrogen.

3. The optical integrated device according to claim 2,
wherein said semiconductor layer in said active layer further composes at least one of antimony and phosphorous.

4. The optical integrated device according to claim 1,
wherein said active layer includes a semiconductor layer made of group III-V compound semiconductor material composing gallium, arsenic, and nitrogen.

5. The optical integrated device according to claim 4,
wherein said semiconductor layer in said active layer further composes at least one of antimony and phosphorous.

6. The optical integrated device according to claim 5,
wherein said semiconductor layer in said active layer is one of GaNAs, GaInNAs, GaNAsSb, GaNAsP, GaNAsSbP, GaInNAsSb, GaInNAsP, and GaInNAsSbP.

7. The optical integrated device according to claim 1,
wherein said first cladding layer is made of at least one of AlGaInP, GaInP and AlGaAs, and said second cladding layer is made of at least one of AlGaInP, GaInP and AlGaAs.

8. The optical integrated device according to claim 1,
further comprises a current blocking layer,
wherein said second cladding layer includes a ridge buried with said current blocking layer.

9. The optical integrated device according to claim 8,
wherein said current blocking layer is made of at least one of AlGaInP, GaInP and AlGaAs.

10. The optical integrated device according to claim 1,
further comprises a current blocking layer,
wherein said first cladding layer, said active region and said second cladding layer form a mesa buried with said current blocking layer.

11. The optical integrated device according to claim 10,
wherein said current blocking layer is made of at least one of AlGaInP, GaInP and AlGaAs.

12. The optical integrated device according to claim 1,
further comprises a first optical confinement layer sandwiched between said first cladding layer and said active region and a second optical confinement layer sandwiched between said active region and said second cladding layer.

13. The optical integrated device according to claim 1,
wherein said first active layer has a first quantum well structure with at least one well layer, and
said third active layer has a third quantum well structure with at least one well layer,
wherein a thickness of said well layer in said third quantum well structure is thinner than a thickness of said well layer in said first quantum well structure such that said band-gap energy of said third active layer is greater than said band-gap energy of said first active layer.

14. The optical integrated device according to claim 13,
wherein said second active layer has a second quantum well structure with at least one well layer, and
wherein a thickness of said well layer in said second quantum well structure gradually thins from said first active layer to said third active layer such that band-gap energy of said second active layer gradually increases from said first active layer to said third active layer.
